(19) United States
(12) Patent Application Publication
(10) Pub. No.: US 2003/0038203 A1
(43) Pub. Date: Feb. 27, 2003

(54) Retractable block heater cord assembly

(76) Inventor: Marvin Ohama, Brooks (CA)

Correspondence Address: GENE SCOTT, PATENT LAW & VENTURE GROUP ITTT, 3151 AIRWAY AVE, SUITE K 105, COSTA MESA, CA, 92626, US

(21) Appl. No.: 09/935,823

(22) Filed: Aug. 23, 2001

(51) Int. Cl. B65H 75/48; H01B 7/06

(52) U.S. Cl. 242/385; 174/69

(57) ABSTRACT

A retractable block heater electrical cord apparatus for use with an automotive block heater has a cord case supporting a cord reel, a retraction coil spring, a retraction clutch, and an electrical cord. The cord case further has a plurality of fixed rigid loops extending outwardly from the cord case for mounting the apparatus to the front of an automobile. The cord is wound onto the cord reel and extends, through an aperture in the cord case, for extending an electrical plug at one end. The retraction coil spring is immovably engaged with an axel integral with the cord case at one end of the spring and with the retraction clutch at the other end. The retraction clutch engages the cord reel so as to prevent the cord reel from retracting when the electrical cord is extended from the cord case.

### BACKGROUND OF THE INVENTION

1. Field of the Invention

This invention relates generally to retractable electrical cord assemblies and more particularly to such an assembly for use with an automobile for heating the engine block in winter.

2. Description of Related Art

The prior art teaches the use of retractable cord assemblies. These devices are frequently built into the housing of an appliance such as a vacuum cleaning equipment or may be a separate unit as for instance used with a drop light or such. The present invention fulfills these same needs in a novel manner for an automobile block heater, and provides further related advantages as described in the following summary.

### SUMMARY OF THE INVENTION

The present invention teaches certain benefits in construction and use which give rise to the objectives described below.

A retractable block heater electrical cord apparatus for use with an automotive block heater has a cord case supporting a cord reel, a retraction coil spring, a retraction clutch, and an electrical cord. The cord case further has a plurality of fixed rigid loops extending outwardly from the cord case for mounting the apparatus to the front of an automobile, or behind the automobile's grill. The cord is wound onto the cord reel and extends, through an aperture in the cord case, for exposing an electrical plug at one end. The retraction coil spring is immovably engaged with an axel integral with the cord case at one end of the spring and with the retraction clutch at the other end. The retraction clutch engages the cord reel so as to prevent the cord reel from retracting when the electrical cord is extended from the cord case. Multiple sockets may be provided on the female end of the electrical cord so as to other electrical appliances using utility supplied power may be used conveniently; such as an interior heater, battery warmer, etc. Thus, this invention saves time and energy and provides convenience.

A primary objective of the present invention is to provide an apparatus and method of use of such apparatus that provides advantages not taught by the prior art.

Another objective is to provide such an invention capable of mounting to a vehicular bumper, behind the grill or other part at the forward end of the vehicle.

A further objective is to provide such an invention capable of showing an electrical fault.

A yet further objective is to prevent theft of electrical cords.

A still further objective is to provide such an invention capable of maintaining a moisture free environment within the reel mechanism.

Other features and advantages of the present invention will become apparent from the following more detailed description, taken in conjunction with the accompanying drawings, which illustrate, by way of example, the principles of the invention.

### BRIEF DESCRIPTION OF THE DRAWINGS

The accompanying drawings illustrate the present invention. In such drawings:

FIG. 1 is an exploded view of the preferred embodiment of the invention;

FIG. 2 is a perspective view thereof as assembled; and

FIG. 3 is a plan view thereof showing the interior portions with one side of the reel case removed.

### DETAILED DESCRIPTION OF THE INVENTION

The above described drawing figures illustrate the invention in at least one of its preferred embodiments, which is further defined in detail in the following description.

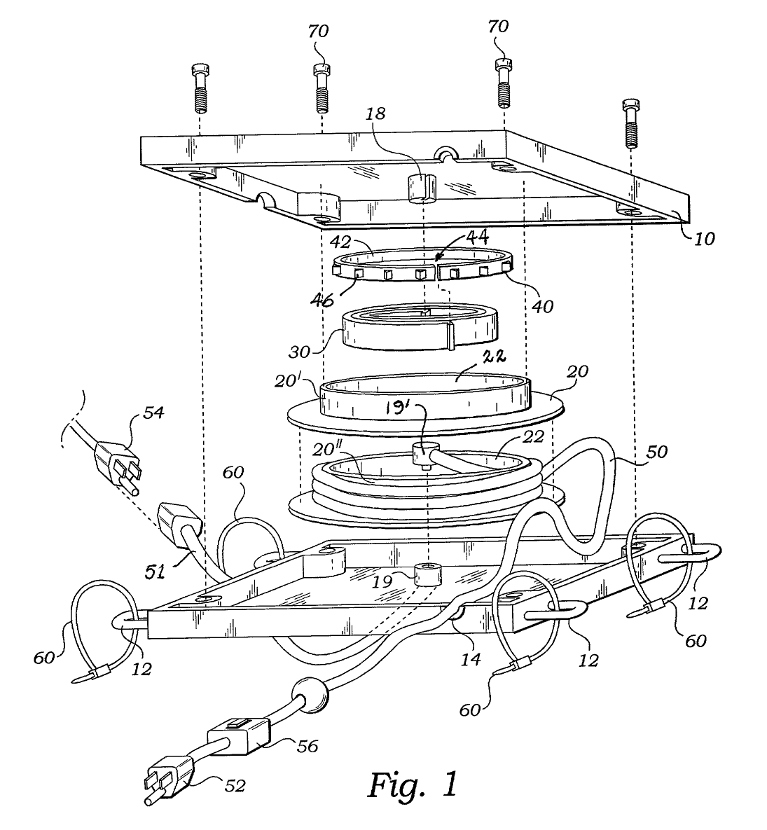

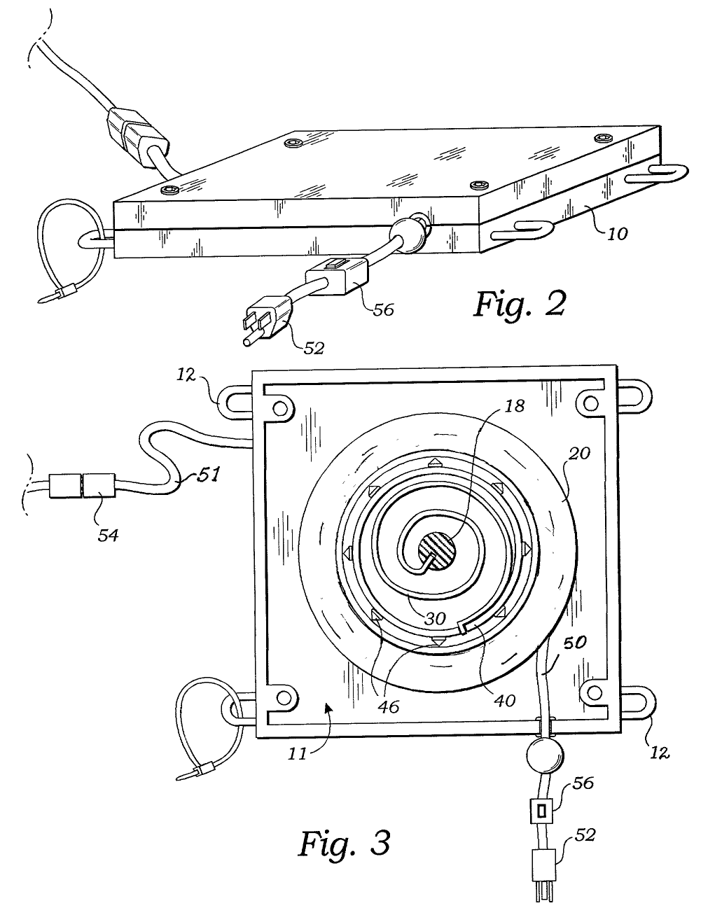

The subject invention is a retractable block heater electrical cord apparatus for use with an automotive block heater (not shown) and comprises a cord case 10 providing within, a cord reel 20, a retraction coil spring 30, a retraction clutch 40, and an electrical cord 50. The cord case 10 further provides a plurality of fixed rigid loops 12 extending outwardly from the cord case 10 for mounting the apparatus to an automobile bumper, grill or the like. The cord 50 is wound onto the cord reel 20, as shown in FIG. 1, and extends, through an aperture 14 in the cord case 10 for exposing an electrical cord plug 52 which is fixed at the terminal end of the electrical cord 50. The retraction coil spring 30 is immovably engaged at its interior end with an axel 18 which is integral with the cord case 10 and with the retraction clutch 40 at its other end. This is clearly shown in FIG. 3. The retraction clutch 40 engages the cord reel 20 within flange 20′ so as to prevent it from rotating when the electrical cord 50 is being extended from the cord case 10. The electrical cord 50 preferably further comprises a ground fault interrupter 56 of any common and well known type, so as to enable automatic circuit disconnection and visual identification should the cord 50 become electrically shorted to ground.

Plural attachment straps 60, shown in FIG. 1, are provided for attaching the fixed rigid loops 12 of the cord case 10 to a vehicle so as to suspend the apparatus in place on the vehicle.

Preferably, the retraction clutch 40 comprises a ring 42 of spring material, slotted 44 for receiving the other end of the coil spring 30 and providing plural radial teeth 46 extending outwardly and functionally positioned for gripping the interior surface 22 of the cord reel 20 when the coil spring 30 moves to retract the electrical cord 50.

The aperture 14 of the cord case 10 is tight fitting around the electrical cord 50 in such a manner as to exclude moisture from an interior space 11 of the cord case 10.

It can be seen in FIG. 1 that the case 10 is easily made of a plastic or metal material in two parts mated by screws 70 in a manner well known to those of skill in the art. The cord reel 20 is also preferably made in two joined parts as shown. Within cylindrical rib 20′ is assembled the coil spring 30 and clutch 40 mounted as shown in FIG. 3. The cord 50 is wound around the cord reel flange 20″ as shown in the figures with one end feed through the flange 20″ and then fixed to a first portion 19′ of a rotational electrical coupling and the other end able to be uncoiled and recoiled as the reel 20 rotates. This rotation is about a second portion 19 of the rotational electrical coupling. The two portions 19 and 19″ are joined in rotational and electrical interconnection and operational communion. The reel 20 also rotates about shaft 18 which is integral with the case 10. The flange 20 is typically bonded to flange 20″. Centrally located holes in reel 20 are positioned for accepting shaft 18 and coupling 19 about which the reel rotates. A lead-in wire 51 is fixed to the second portion 19 and extends from the case 10 for accepting a block heater plug and/or other accessories.

While the invention has been described with reference to at least one preferred embodiment, it is to be clearly understood by those skilled in the art that the invention is not limited thereto. Rather, the scope of the invention is to be interpreted only in conjunction with the appended claims.

What is claimed is:

1. A retractable block heater electrical cord apparatus for use with an automotive block heater which comprises: a cord case providing within, a cord reel, a retraction coil spring, a retraction clutch, and an electrical cord, the cord case further providing a plurality of fixed rigid loops extending outwardly from the cord case for mounting the apparatus to an automobile, wherein, the cord is wound onto the cord reel and extends, therefrom, through an aperture in the cord case for extending an electrical cord joining device fixed to a terminal end of the electrical cord, the retraction coil spring is immovably engaged with an axel integral with the cord case at one end of the spring and with the retraction clutch at the other end thereof, the retraction clutch engaging the cord reel so as to prevent the cord reel from retracting when the electrical cord is extended from the cord case.

2. The apparatus of claim 1 wherein the electrical cord further comprises a ground fault interrupter.

3. The apparatus of claim 1 further comprising plural attachment straps enabled for attaching the fixed rigid loops of the cord case to a vehicle.

4. The apparatus of claim 1 wherein the retraction clutch comprises a ring of spring material, slotted for receiving the other end of the coil spring and providing plural radial teeth extending outwardly therefrom functionally positioned for gripping the cord reel when the coil spring moves to retract the electrical cord.

5. The apparatus of claim 1 wherein the aperture of the cord case is tight fitting around the electrical cord in a manner as to exclude moisture from an interior space of the cord case.
